(19) United States
(12) Patent Application Publication
(10) Pub. No.: US 2026/0012316 A1
(43) Pub. Date: Jan. 8, 2026

(54) POSITIONING

(71) Applicant: Nokia Technologies Oy, Espoo (FI)

(72) Inventors: Hyun-Su CHA, Naperville, IL (US); Ryan KEATING, Naperville, IL (US); Tao TAO, Shanghai (CN)

(21) Appl. No.: 19/123,173

(22) PCT Filed: Oct. 27, 2022
(86) PCT No.: PCT/CN2022/128071

§ 371 Date: Apr. 22, 2025

(51) Int. Cl. H04L 5/00; H04W 64/00

(52) U.S. Cl. CPC H04L 5/0064; H04L 5/0044; H04L 5/0048; H04W 64/00

(57) ABSTRACT

Embodiments of the present disclosure relate to for positioning. A first device receives. from a second device for a radio access network. priority configuration for transmission of a first RS for positioning the first device on frequency hops. The priority configuration is indicative of a first priority for the transmission of the first RS on the frequency hops and a second priority for one or more transmissions other than the transmission of the first RS at time occasions associated with the frequency hops. The first device determines if the first priority for the transmission of the first RS is higher than the second priority based at least on the priority configuration. If the first priority is higher than the second priority. the first device performs the transmission of the first RS on the frequency hops.

### FIELD

Embodiments of the present disclosure generally relate to the field of telecommunication and in particular, to devices, methods, apparatus and computer readable storage media for positioning.

### BACKGROUND

A New radio (NR) system provides positioning support. In Release 18 NR Study Item Description (SID), positioning enhancement includes positioning support for Reduced Capability (RedCap) devices with reduced bandwidth support and reduced complexity including number of receiving radio frequency (RF) chains.

In Release 17 NR work item, the considered maximum bandwidth of the RedCap devices was 20 MHz for FRI and it would be 5 MHz in Release 18. The Third Generation Partnership Project (3GPP) evaluated performance assuming 100 MHz bandwidth for FRI and the performance could be worse in the narrow band system due to the low sampling rate. Furthermore, 3GPP is considering that RedCap devices may be equipped with only a single antenna as a baseline.

RedCap devices could support NR positioning functionality but there is a gap in that the core and performance requirements have not been specified for the positioning related measurements performed by RedCap devices, and no evaluation was performed to see how the reduced capabilities of RedCap devices might impact eventual position accuracy. It may be desirable to support positioning for a reduced capability (RedCap) terminal device with reduced bandwidth and reduced number of receive RF chains.

### SUMMARY

In general, example embodiments of the present disclosure provide a solution for positioning.

In a first aspect, there is provided a first device for a radio access network. The first device comprises at least one processor and at least one memory storing instructions.

When the instructions are executed by the at least one processor, the instructions cause the first device at least to: receive, from a second device for the radio access network, priority configuration for transmission of a first reference signal (RS) for positioning the first device on frequency hops, wherein the priority configuration is indicative of a first priority for the transmission of the first RS on the frequency hops and a second priority for one or more transmissions other than the transmission of the first RS at time occasions associated with the frequency hops: determine if the first priority for the transmission of the first RS is higher than the second priority based at least on the priority configuration: and based on the determination that the first priority is higher than the second priority, perform the transmission of the first RS on the frequency hops.

In a second aspect, there is provided a second device for a radio access network. The second device comprises at least one processor and at least one memory storing instructions. When the instructions are executed by the at least one processor, the instructions cause the second device at least to: determine priority configuration for transmission of a first RS on frequency hops, wherein the first RS is for positioning a first device for the radio access network, the priority configuration is indicative of a first priority for the transmission of the first RS on the frequency hops and a second priority for transmission of other channels or signals than the first RS: and transmit the priority configuration to the first device.

In a third aspect, there is provided a method. The method may be performed by a first device for a radio access network and comprises: receiving, at the first device from a second device for the radio access network, priority configuration for transmission of a first reference signal, RS, for positioning the first device on frequency hops, wherein the priority configuration is indicative of a first priority for the transmission of the first RS on the frequency hops and a second priority for one or more transmissions other than the transmission of the first RS at time occasions associated with the frequency hops: determining if the first priority for the transmission of the first RS is higher than the second priority based at least on the priority configuration: and based on a determination that the first priority is higher than the second priority, performing the transmission of the first RS on the frequency hops.

In a fourth aspect, there is provided a method. The method may be performed by a second device for a radio access network and comprises: determining, at the second device, priority configuration for transmission of a first RS on frequency hops, wherein the first RS is for positioning a first device for the radio access network, the priority configuration is indicative of a first priority for the transmission of the first RS on the frequency hops and a second priority for one or more transmissions other than the transmission of the first RS at time occasions associated with the frequency hops: and transmitting the priority configuration to the first device.

In a fifth aspect, there is provided a first apparatus. The first apparatus comprises: means for receiving, at a first device for a radio access network from a second device for the radio access network, priority configuration for transmission of a first reference signal, RS, for positioning the first device on frequency hops, wherein the priority configuration is indicative of a first priority for the transmission of the first RS on the frequency hops and a second priority for one or more transmissions other than the transmission of the first RS at time occasions associated with the frequency hops: means for determining if the first priority for the transmission of the first RS is higher than the second priority based at least on the priority configuration: and means for performing the transmission of the first RS on the frequency hops based on a determination that the first priority is higher than the second priority.

In a sixth aspect, there is provided a second apparatus. The second apparatus comprises: means for determining, at a second device for a radio access network, priority configuration for transmission of a first RS on frequency hops, wherein the first RS is for positioning a first device for the radio access network, the priority configuration is indicative of a first priority for the transmission of the first RS on the frequency hops and a second priority for one or more transmissions other than the transmission of the first RS at time occasions associated with the frequency hops: and means for transmitting the priority configuration to the first device.

In a seventh aspect, there is provided a computer readable medium. The computer readable medium comprises program instructions that, when executed by at least one processor, cause an apparatus to perform at least the method according to any of the third and fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented:

FIG. 2 illustrates an example of multi-RTT (Round Trip Time) positioning in accordance with some example embodiments of the present disclosure:

FIG. 3 illustrates an example of frequency hopping for a reference signal in accordance with some example embodiments of the present disclosure:

FIG. 4 illustrates an example of frequency hopping for a reference signal in accordance with some other example embodiments of the present disclosure:

FIG. 5 illustrates a signaling chart illustrating a process for positioning in accordance with some example embodiments of the present disclosure:

FIG. 6 illustrates a signaling chart illustrating a process for positioning in accordance with some other example embodiments of the present disclosure:

FIG. 7 illustrates an example of frequency hopping for a reference signal in accordance with still other example embodiments of the present disclosure;

FIG. 8 illustrates a flowchart of a method implemented at a first device in accordance with some example embodiments of the present disclosure:

FIG. 9 illustrates a flowchart of a method implemented at a second device in accordance with other example embodiments of the present disclosure:

FIG. 10 illustrates a simplified block diagram of an apparatus that is suitable for implementing embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. An RAN split architecture comprises a gNB-CU (Centralized unit, hosting RRC, SDAP and PDCP) controlling a plurality of gNB-DUs (Distributed unit, hosting RLC, MAC and PHY).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

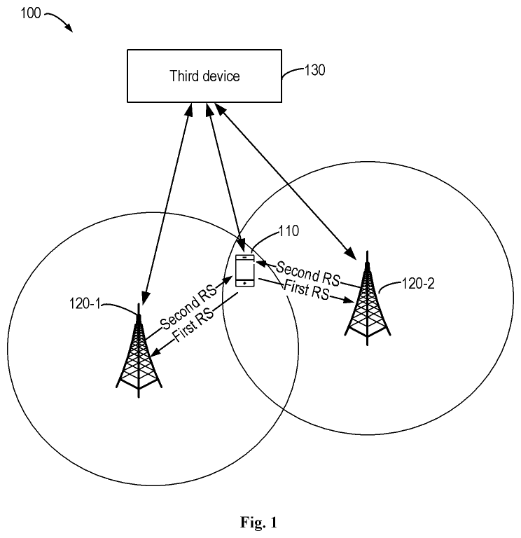

FIG. 1 shows an example communication network 100 in which embodiments of the present disclosure can be implemented. The network 100 may comprise a first device 110, second devices 120-1 and 120-2, and a third device 130 that can communicate with each other. Hereinafter, for brevity, the second devices 120-1 and 120-2 may be collectively referred to as second devices 120 or individually referred to as a second device 120.

In some embodiments, some of the first device 110, the second devices 120 and the third device 130 may be implemented as terminal devices, and others may be implemented as network devices. In such embodiments, for example, the first device 110 may be implemented as a terminal device for a radio access network. For example, the first device 110 may be implemented as a Reduced Capability (RedCap) device. In such embodiments, the second device 120 may be implemented as a network device for the radio access network, and the third device 130 may be implemented as a network device for the radio access network or for a core network. For example, the second device 120 may be implemented as a gNB and the third device 130 may be implemented as a Location Management Function (LMF) entity. The LMF entity may be implemented in the radio access network or in the core network.

In such embodiments, the second device 120-1 may be serving the first device 110, and the second device 120-2 may be not serving the first device 110. In such embodiments, the second device 120-1 may be referred to as a serving network device and the second device 120-2 may be referred to as a neighbor network device.

In addition, in such embodiments, each of the second devices 120-1 and 120-2 may be implemented as a transmission reception point (TRP).

In other embodiments, each of the first device 110, the second devices 120 and the third device 130 may be implemented as a terminal device. In such embodiments, the first device 110, the second devices 120 and the third device 130 may communicate with each other via a sidelink therebetween.

It is to be understood that the number of network devices and terminal devices is only for the purpose of illustration without suggesting any limitations. The network 100 may include any suitable number of network devices and terminal devices adapted for implementing embodiments of the present disclosure. Although not shown, it would be appreciated that one or more terminal devices may be served by the second device 120. In addition, it would be appreciated that there may be more neighbor network devices near the terminal device.

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some embodiments, Multi-cell Round Trip Time (Multi-RTT) positioning of the first device 110 may be performed in the network 100.

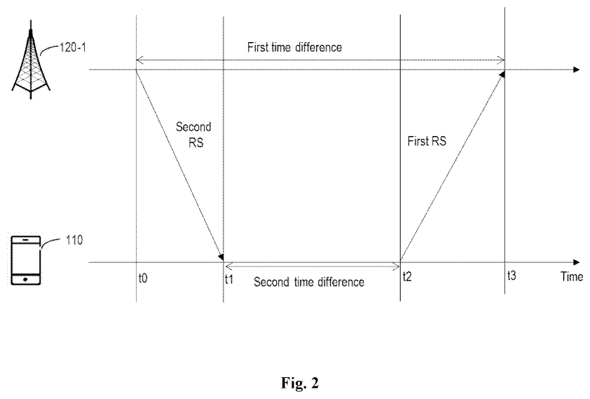

FIG. 2 illustrates an example of multi-RTT positioning in accordance with some example embodiments of the present disclosure. As shown in FIG. 2, for the purpose of multi-RTT positioning, the second device 120-1 transmits a second reference signal (RS) to the first device 110 and records the time (represented by t0) of transmitting the second RS. Upon receiving the second RS from the second device 120-1, the first device 110 records the time (represented by t1) of receiving the second RS.

The first device 110 transmits a first RS to the second device 120-1 and records the time (represented by t2) of transmitting the first RS. Upon receiving the first RS from the first device 110, the second device 120-1 records the time (represented by t3) of receiving the first RS. In turn, the second device 120-1 may determine a first time difference between t3 and t0, i.e., t3−t0.

In some embodiments, the first device 110 may determine a second time difference between t2 and t1 (i.e., t2−t1) and transmit the second time difference to the second device 120-1.

Upon receiving the second time difference (t2−t1), the third device 130 may determine a first RTT between the second device 120-1 and the first device 110 based on the first time difference and the second time difference. For example, the second device 120-1 may report the first time difference (t3−t0) to the third device and the first device may report the second time difference (t2−t1). Based on the provided measurement information, the third device determine the first RTT to be a difference between the first time difference and the second time difference, i.e., (t3−t0)−(t2−t1).

Similarly, the third device 130 may determine a second RTT between the second device 120-2 and the first device 110.

In some embodiments, the second device 120-1 and the second device 120-2 may transmit the Rx-Tx time difference measurement(s) to the third device 130, respectively. Alternatively, the first device 110 and the second devices 120 may transmit respective time differences to the third device 130 directly and the third device 130 may determine the respective RTTs. In turn, the third device 130 may determine a position of the first device 110 based on the first RTT and the second RTT.

Alternatively, the second device 120-2 may transmit the second RTT to the second device 120-1. In turn, the second device 120-1 may determine the position of the first device 110 based on the first RTT and the second RTT.

In some embodiments, the first RS may include but is not limited to sounding reference signals (SRS), and the second RS may include but is not limited to positioning reference signals (PRS). The first RS may include sidelink positioning reference signals. The sidelink positioning reference signals may include RS transmitted from a UE to another UE for positioning purpose. Hereinafter, embodiments of the present disclosure will be described by taking SRS and PRS for example. However, other types of reference signals may be applied to the embodiments of the present disclosure.

The frequency bandwidth resource is the critical factor to the positioning accuracy for both downlink (DL) and uplink (UL) positioning, especially for TDOA (Time Difference Of Arrival) and Multi-RTT positioning techniques as they use timing measurements. To overcome performance degradation from the narrow bandwidth resource, frequency hopping for at least one of the first RS and the second RS may be applied so as to increase the effective bandwidth for positioning while keeping the instantaneous bandwidth within a maximum bandwidth, such as the RedCap maximum bandwidth. For example, the RedCap maximum bandwidth may be 20 MHz for FR1 and 100 MHz for FR2. In this way, at least one of the first RS and the second RS may be transmitted in the narrow SRS bandwidth each time and coherent processing across multiple frequency hops is enabled at the second device 120.

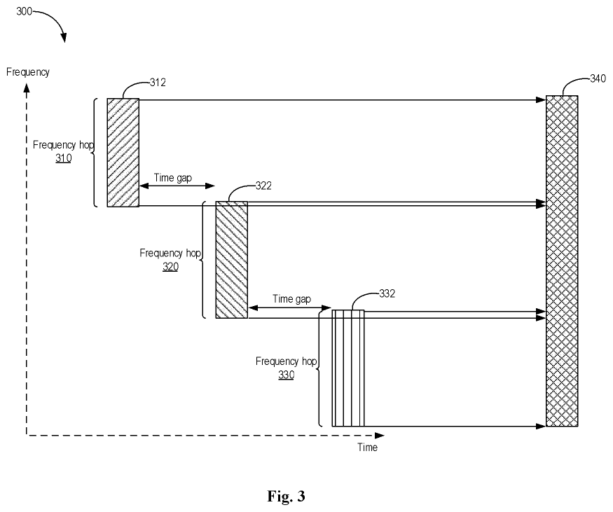

FIG. 3 illustrates an example 300 of frequency hopping for SRS in accordance with some example embodiments of the present disclosure. In the example 300, each of frequency hops 310, 320 and 330 is composed of a single SRS resource. In this regard, the frequency hops 310, 320 and 330 may be referred to as SRS resources 310, 320 and 330.

As shown in FIG. 3, the first device 110 transmits an SRS on each of the frequency hops 310, 320 and 330 sequentially. For example, the first device 110 transmits the SRS at each of transmission occasions 312, 322 and 332. The first RS may include SRS for positioning or SRS for MIMO. Hereinafter, the transmission occasion is also referred to as a time occasion. In other words, in the example 300, the first RS may be a single SRS.

A single SRS frequency hop may be defined within a single UL BWP. For example, the bandwidth of the single UL BWP may be 20 MHz.

The first device 110 may transmit each of the three SRS at a respective UL bandwidth part (BWP). That is, the three SRS are transmitted through three different uplink BWPs. In order to transmits the three SRS on different frequency hops, the first device 110 may need to perform BWP switching. Thus, there is a time gap for RF switching between the transmission occasion 312 and the transmission occasion 322, and there is a time gap for RF switching between the transmission occasion 322 and the transmission occasion 332.

The second device 120 receives the three SRS on the frequency hops 310, 320 and 330, stitches the three SRS, performs coherent processing to extract a single positioning measurement from a wideband SRS 340.

In the example 300, however, if the first device 110 missed a chance to transmit an SRS on the frequency hop 320 but it transmitted the SRS on each of the frequency hops 310 and 330, the second device 120 would not be able to do coherent processing.

Based on Release 16 and Release 17 NR positioning, it is feasible that the first device 110 drops SRS transmission when there is collision between transmission of Physical Uplink Shared Channel (PUSCH) and SRS. In TS 38.214, it is specified that “For operation on the same carrier, if an SRS configured by the higher parameter SRS-PosResource collides with a scheduled PUSCH, the SRS is dropped in the symbols where the collision occurs.”

For SRS frequency hopping, missing a chance to transmit an SRS on a specific SRS frequency hop should be addressed.

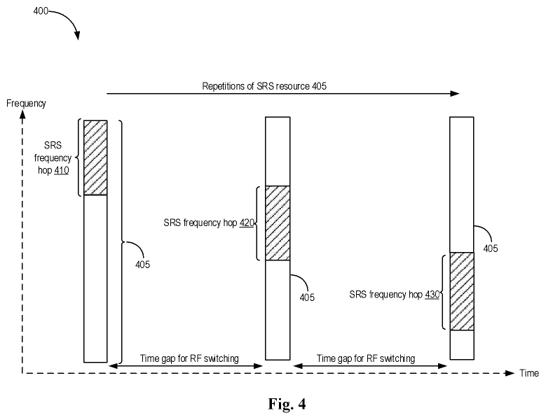

FIG. 4 illustrates an example 400 of frequency hopping for SRS in accordance with some example embodiments of the present disclosure. In the example 400, all configured frequency hops 410, 420 and 430 are composed of a single SRS resource 405. In this regard, each of the frequency hops 410, 420 and 430 may be referred to as a part of the single SRS resource 405 or a repetition of single SRS resource 405.

In the example 400, the SRS resource configuration may include a repetition number for inter-slot and/or intra-slot repetition. For example, the first device 110 may be configured with the SRS resource 405 and the configured repetition number is 3. At each of the repetitions 410, 420 and 430 (i.e., at each of transmission occasions), the first device 110 transmits a part of the SRS but it may be up to the first device 110 on which part the first device 110 should transmit. In other words, in the example 400, the first RS may be a “piece” or “segment” of an SRS. It will be understood that from the receiver point of view, all the pieces or segments of an SRS can be considered as a single SRS after they are combined.

The difference between the example 300 and the example 400 is that in the example 300, the second device 120 configures which SRS frequency hop should be transmitted at each of the SRS transmission occasions, so the second device 120 can avoid the unnecessary frequency resource allocation. The example 400 needs to reserve unnecessary frequency resource but configuration method may be simple.

In order to solve the above and other potential problems, embodiments of the present disclosure provide a solution for positioning. In the solution, a first device receives, from a second device for the radio access network, priority configuration for transmission of a first RS for positioning the first device on frequency hops. The priority configuration is indicative of a first priority for the transmission of the first RS on the frequency hops and a second priority for one or more transmissions other than the transmission of the first RS at time occasions associated with the frequency hops. The first device determines if the first priority for the transmission of the first RS is higher than the second priority based at least on the priority configuration. If the first priority is higher than the second priority, the first device performs the transmission of the first RS on the frequency hops. In this way, the transmission of the first RS at the time occasions may be ensured. Thus, missing a chance to transmit the first RS on a specific frequency hop may be avoided.

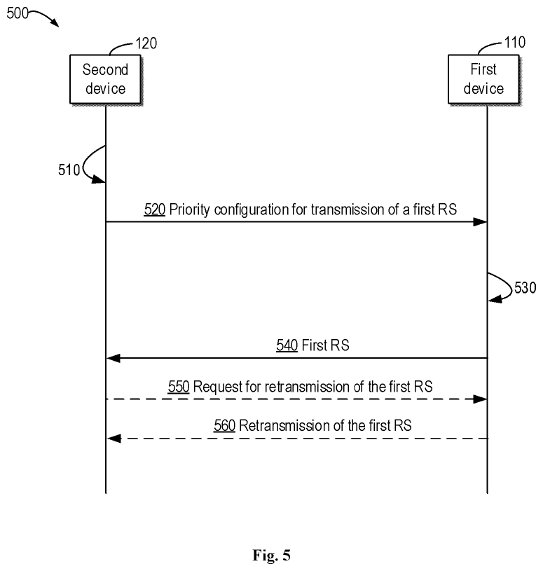

Hereinafter, some embodiments of the present disclosure according to the first aspect will be described with reference to FIGS. 5 to 9.

FIG. 5 illustrates a signaling chart illustrating a process 500 for positioning in accordance with some example embodiments of the present disclosure. For the purpose of discussion, the process 500 will be described with reference to FIG. 1. The process 500 may involve the first device 110 and the second device 120 in FIG. 1.

As shown in FIG. 5, the second device 120 determines 510 priority configuration for transmission of the first RS for positioning the first device 110 on frequency hops. The priority configuration is indicative of a first priority for the transmission of the first RS on the frequency hops and a second priority for one or more transmissions other than the transmission of the first RS at time occasions associated with the frequency hops.

In some embodiments, the one or more transmissions other than the transmission of the first RS comprise transmission of at least one of PUSCH, Physical Uplink Control Channel (PUCCH), Physical Random Access Channel (PRACH) or reference signals other than the first RS.

The second device 120 transmits 520 the priority configuration to the first device 110.

Upon receiving the priority configuration from the second device 120, the first device 110 determines 530 if the first priority for the transmission of the first RS is higher than the second priority based at least on the priority configuration. In turn, based on a determination that the first priority is higher than the second priority, the first device 110 performs 540 the transmission of the first RS on the frequency hops.

For example, the first device 110 may determine that the first priority is higher than the second priority by comparing the first priority with the second priority. In an example, the first device 110 refrains from performing (i.e., does not perform) the transmission of the first RS on the frequency hops based on determining that the first priority is lower than the second priority. In such case, the first device 110 may instead transmit some other transmission(s), such as PUSCH transmission.

In the process 500, if the first priority for the transmission of the first RS is higher than the second priority for the one or more transmissions other than the transmission of the first RS at the time occasions associated with the frequency hops, the first device 110 performs 540 the transmission of the first RS on the frequency hops. In this way, the transmission of the first RS at the time occasions may be ensured. Thus, missing a chance to transmit the first RS on a specific frequency hop may be avoided.

In some embodiments, the first RS may be a single SRS, as described with reference to FIG. 3. Alternatively, the first RS may be a “piece” or “segment” of an SRS, as described with reference to FIG. 4.

In some embodiments, the second device 120 may not successfully receive the first RS on the specific frequency hops or obtain positioning measurement of the first RS. In such embodiments, the second device 120 may transmit 550, to the first device 110, a request for retransmission of the first RS using a dedicated frequency hop.

Upon receiving the request, the first device 110 may retransmit 560 the first RS to the second device 120 using the dedicated frequency hop.

In some embodiments, the first RS may include but is not limited to SRS. Hereinafter, embodiments of the present disclosure will be described by taking SRS for example. However, other types of reference signals may be applied to the embodiments of the present disclosure.

In some embodiments, the second device 120 transmits configuration information associated with the first RS to the first device 110. The configuration information may indicate multiple consecutive frequency hops within a periodicity of an SRS resource for the transmission of the SRS. Hereinafter, the number of the multiple consecutive frequency hops within the periodicity of the SRS resource is represented by M.

In some embodiments, the priority configuration may comprise a first number of consecutive frequency hops for the transmission of the first RS. Hereinafter, the first number is represented by K, where 1<K≤M.

In some embodiments, the first number (K) is associated with first positioning performance for the first device 110. For example, the first positioning performance may be a desired positioning performance. For example, the desired positioning performance may be horizontal positioning accuracy less than 1 m error. To achieve this positioning performance, at least four frequency hops are required, where 20 MHz may be for each frequency hop. The first device may be configured with K=4.

In some embodiments, the first device 110 may determine the first priority for the transmission of the first RS on the first number (K) of consecutive frequency hops to be higher than the second priority for the transmission of other channels or signals. In other words, the first device 110 may put a higher priority on the transmission of the first RS on the first number (K) of consecutive frequency hops. Until the first device 110 transmits the first RS from the first number (K) of consecutive frequency hops, the first device 110 does not drop any transmission of the first RS even if there is scheduled PUSCH on Orthogonal Frequency Division Multiplex (OFDM) symbols configured with at least one resource for the first RS.

In some embodiments, the first device 110 may determine the first priority for the transmission of the first RS on the first number (K) of consecutive frequency hops to be lower than the second priority. If the transmission of the first RS is not performed on at least one of the first number (K) of consecutive frequency hops, the first device 110 may determine not to perform the transmission of the first RS on remaining consecutive frequency hops among the first number (K) of consecutive frequency hops.

In such embodiments, while the first device 110 transmits the first RS, the first device 110 follows the legacy rule such that PUSCH transmission has higher priority than the transmission of the first RS. However, if the first device 110 determines that it is not able to transmit the first RS on at least one of the first number (K) of consecutive frequency hops, it drops transmission of remaining parts of the first RS on the remaining frequency hops. Alternatively, the first device 110 may assume the transmission of the first RS has a lower priority for the rest of the frequency hops, even if some of the rest of the frequency hops do not contain PUSCH (or other high priority of channel(s) and reference signal(s)) on the same symbol(s).

In some embodiments, the priority configuration may comprise a second number of consecutive frequency hops for the transmission of the first RS. Hereinafter, the second number is represented by L, where 1<L<K.

In some embodiments, the second number (L) is associated with second positioning performance for the first device 110. The second positioning performance is lower than the first positioning performance. For example, the second positioning performance may be a minimum positioning performance. For example, the minimum positioning performance may be horizontal positioning accuracy less than 3 m error. To achieve this positioning performance, at least two frequency hops are required, where 20 MHz may be for each frequency hop. The first device may be configured with K=2.

In some embodiments, the first device 110 may determine the first priority for the transmission of the first RS on the second number (L) of consecutive frequency hops to be lower than the second priority. If the transmission of the first RS is successfully performed on the second number (L) of consecutive frequency hops, the first device 110 may determine the first priority for the transmission of the first RS on a fourth number consecutive frequency hops to be higher than the second priority.

In some embodiments, the priority configuration comprises the first number and the second number, and the fourth number is equal to a difference between the first number (K) and the second number (L), i.e., K−L.

For example, suppose N represents the number of the first RS which were transmitted on consecutive frequency hops. If 1<N<=L, legacy priority rule is applied for the transmission of the first RS and PUSCH transmission. That is, the first RS transmission has a lower priority than the PUSCH transmission. If L<N<=K, the first RS transmission has higher priority than the PUSCH transmission.

Alternatively, in some embodiments, the fourth number is equal to a difference between a number of time occasions associated with the transmission of the first RS (M) and the second number (L). For example, the number of time occasions associated with the transmission of the first RS may be the number of the multiple consecutive frequency hops within the periodicity of the SRS resource.

In such embodiments, the first device 110 may follow the legacy priority rule while transmitting the first RS from the second number (L) of consecutive frequency hops. That is, the first device 110 transmits the first RS on the L consecutive frequency hops complying with the legacy rule (i.e., PUSCH has higher priority than the first RS). If the first device 110 successfully transmits the first RS on the second number (L) of consecutive frequency hops, the first device 110 puts a higher priority on the transmission of the first RS for the rest (K−L) frequency hops. Such embodiments may guarantee transmission of the first RS on the first number (K) of consecutive frequency hops to support the first positioning performance (such as the desired positioning performance).

Alternatively, in some embodiments, the first device 110 may determine the first priority for the transmission of the first RS on the second number (L) of consecutive frequency hops to be higher than the second priority. If the transmission of the first RS is successfully performed on the second number (L) of consecutive frequency hops, the first device 110 may determine the first priority for the transmission of the first RS on a fourth number consecutive frequency hops to be lower than the second priority. The fourth number is equal to a difference between the first number (K) and the second number (L), i.e., K−L.

For example, suppose N represents the number of the first RS which were transmitted on consecutive frequency hops. If 1<N<=L, a high priority is applied for the transmission of the first RS and a low priority is applied for PUSCH transmission. If L<N<=K, a lower priority is applied for the transmission of the first RS and a high priority is applied for PUSCH transmission

In such embodiments, after the first device 110 successfully transmits the first RS on the second number (L) of consecutive frequency hops, the first device 110 deprioritize the transmission of the first RS for the rest (K−L) frequency hops. That is, such embodiments guarantee transmission of the first RS on the at least the second number (L) of consecutive frequency hops

As described above, in some embodiments, multi-RTT positioning of the first device 110 may be performed in the network 100.

In embodiments where multi-RTT positioning of the first device 110 is performed, the first device 110 may firstly receive the second RS from the second device 120, and then transmit the first RS to the second device 120, as shown in FIG. 2. In such embodiments, the first device 110 may determine the first priority for the transmission of the first RS based on reception and measurement of the second RS.

In some embodiments, the priority configuration may comprise a third number of consecutive frequency hops for reception of the second RS from the second device 120. Hereinafter, the third number is represented by Z, where Z>1.

In some embodiments, if the second RS is successfully received on a fifth number of consecutive frequency hops and positioning measurement of the second RS is successfully performed on the fifth number of consecutive frequency hops, the first device 110 may determine the first priority for the transmission of the first RS to be higher than the second priority for the transmission of other channels or signals.

In some embodiments, the fifth number is received from the second device 120.

In some embodiments, the positioning measurement may comprise at least one of the following: timing measurement, carrier phase measurement, Reference Signal Receiving Power (RSRP), Reference Signal Receiving Power per signal path (RSRPP) or Reference Signal Receiving Quality (RSRQ).

In some embodiments, the fifth number may be greater than the third number (Z). For example, the fifth number may be equal to the total number of consecutive frequency hops configured for reception of the second RS from the second device 120. In such embodiments, if the first device 110 successfully received all the configured PRS on the fifth number of the frequency hops, and if the first device 110 successfully measured positioning measurement from the PRS from the frequency hops, the first device 110 puts a high priority on the transmission of SRS on frequency hops. It will be note that the high priority on the transmission of SRS on frequency hops means that the first device 110 transmits the SRS on frequency hops although PUSCH is scheduled on the symbols where the SRS frequency hops are configured.

In other embodiments, the fifth number may be equal to the third number (Z). In such embodiments, once the first device 110 successfully received the third number (Z) of PRS on frequency hops that are required to provide a certain level of performance, and the first device 110 successfully measured positioning measurement from the third number (Z) of PRS on the frequency hops, then the first device 110 ignores legacy behavior of higher priority for PUSCH transmission and it puts a higher priority on the transmission of SRS on frequency hops. It will be noted that the higher priority for the transmission of SRS on frequency hops means that the first device 110 transmits the SRS on frequency hops although PUSCH is scheduled on the symbols where the SRS frequency hops are configured.

In some embodiments, the first device 110 may determine not to perform the transmission of the first RS on the frequency hops. In such embodiments, if the first device 110 determines that the second RS is not successfully received on at least one of the third number (Z) of consecutive frequency hops and positioning measurement of the second RS is not successfully performed on the at least one of the third number (Z) of consecutive frequency hops, the first device 110 may determine not to perform the transmission of the first RS on the frequency hops.

In such embodiments, if the first device 110 did not successfully receive the PRS on frequency hops that are required to provide a certain level of performance, and if the first device 110 did not successfully measure positioning measurement from the PRS on the frequency hops, the first device 110 drops transmission of SRS on the frequency hops. In addition, the first device 110 may report to the third device 130 that it has failed to obtain positioning measurement.

In embodiments where multi-RTT positioning of the first device 110 is performed, the first device 110 may firstly transmit the first RS to the second device 120 and then receive the second RS from the second device 120. In such embodiments, the first device 110 may determine a third priority for measurement of the second RS received from the second device 120.

In some embodiments, if the first RS is successfully transmitted on a sixth number of consecutive frequency hops, the first device 110 may determine the third priority for the measurement of the second RS to be higher than a fourth priority for receiving or processing other channels or signals than the second RS.

In some embodiments, the sixth number is received from the second device 120.

In some embodiments, the at least one channel or the at least one signal other than the second RS may include but are not limited to Physical Downlink Shared Channel (PDSCH) or reference signals other than PRS.

In some embodiments, the sixth number may be greater than the first number (K). For example, the sixth number may be equal to the number (M) of the multiple consecutive frequency hops within the periodicity of the SRS resource. In such embodiments, if the first device 110 successfully transmits all the configured SRS on the M frequency hops, the first device 110 puts a higher priority on the measurement of PRS on frequency hops within the PRS processing window. That is, if the priority for the PRS measurement is configured as “low”, the first device 110 puts a high priority on the PRS measurement by ignoring the configured priority.

In some embodiments, the sixth number may be equal to the first number (K). In such embodiments, once the first device 110 successfully transmitted the sixth number of SRS on frequency hops that are required to provide a certain level of performance, then the first device 110 puts a higher priority on the measurement of PRS on frequency hops. That is, if the priority for the PRS measurement is configured as “low”, the first device 110 puts a high priority on the PRS measurement by ignoring the configured priority.

In some embodiments, if the first RS is not successfully transmitted on at least one of a seventh number of consecutive frequency hops, the first device 110 may determine the third priority for the measurement of the second RS to be lower than a fourth priority for receiving or processing other channels or signals than the second RS. In such embodiments, if the first device 110 did not successfully transmit the SRS on frequency hops that are required to provide a certain level of performance, and if the first device 110 did not successfully measure positioning measurement from the PRS on frequency hops, the first device 110 puts a lower priority on the PRS measurement within the PRS processing window.

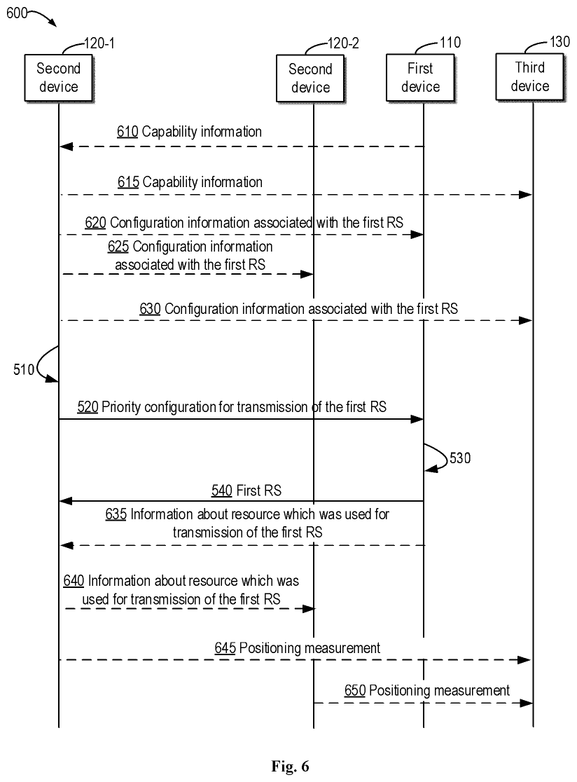

FIG. 6 illustrates a signaling chart illustrating a process 600 for positioning in accordance with some example embodiments of the present disclosure. The process 600 may be considered as an example implementation of the process 500. For the purpose of discussion, the process 600 will be described with reference to FIG. 1. The process 600 may involve the first device 110 and the second device 120 and the third device 130 in FIG. 1.

In the process 600, the second device 120-1 may be serving the first device 110, and the second device 120-2 may be not serving the first device 110. In such embodiments, the second device 120-1 may be referred to as a serving network device and the second device 120-2 may be referred to as a neighbor network device.

The actions 510, 520, 530 and 540 in the process 600 are the same as those in the process 500. Details of these actions are omitted for brevity.

The process 600 is different from the process 500 in actions 610, 615, 620, 625, 630, 635, 640, 645 and 650.

Specifically, the first device 110 transmit 610 capability information to the second device 120-1. The capability information may indicate the first device 110 is a normal UE or RedCap UE.

Upon receiving the capability information, the second device 120-1 may transmit 615 the capability information to the third device 130. Alternatively, the first device 110 may transmit the capability information to the third device 130 directly.

The second device 120-1 transmits 620 configuration information associated with the first RS to the first device 110. The configuration information may comprise at least one of the following: identifiers (IDs) of the resources for transmission of the first RS, or IDs of frequency hops for transmission of the first RS.

For example, the configuration information may indicate multiple SRS resources across multiple UL BWPs within a periodicity of SRS resources, as shown in FIG. 3. For another example, the configuration information may indicate multiple repetitions of a single SRS resource across multiple UL BWPs within a periodicity of the SRS resource, as shown in FIG. 4.

The second device 120-1 transmits 625 the configuration information associated with the first RS to the second device 120-2. The configuration information may comprise information on which frequency hop is used at each transmission occasion for the first RS. The information helps the second device 120-2 (such as a neighbor gNB) measure the first RS on the frequency hops and perform stitching operation.

The second device 120-1 transmits 630 the configuration information associated with the first RS to the third device 130.

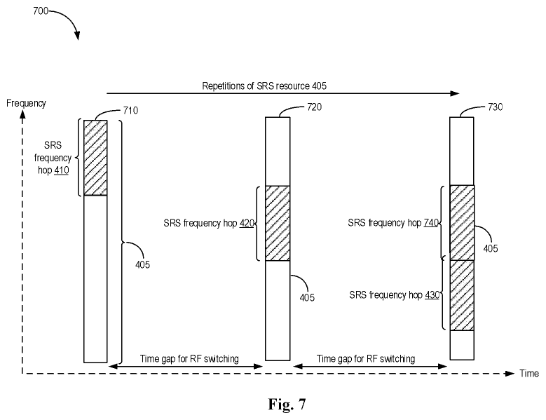

In some embodiments, the first device 110 may have transmitted the first RS on a frequency hop at a different transmission occasion than the configured transmission occasion. This will be described with reference to FIG. 7.

FIG. 7 illustrates an example 700 of frequency hopping for SRS in accordance with some example embodiments of the present disclosure.

The example 700 is similar to the example 400. The example 700 is different from the example 400 in that in the example 700, the first device 110 transmitted the first part of SRS on the frequency hop 410 at a first time occasion 710, but the first device 110 could not transmit the second part of SRS on the frequency hop 420 at a second time occasion 720. Then, the first device 110 puts a high priority on the transmission of the second part of SRS. That is, as shown in FIG. 7, although the third part of SRS is supposed to be transmitted at a third time occasion 730, the first device 110 should try to transmit the second part of SRS on the frequency hop 430 or on a frequency hop 740 at a third time occasion 730 if the first device 110 could not transmit the second part of SRS on the frequency hop 420 at the second time occasion 720.

Return to FIG. 6. In embodiments where the first device 110 has transmitted the first RS on a frequency hop at a different transmission occasion than the configured transmission occasion, the first device 110 may transmit 635, to the second device 120-1, the information about resources which was used for the transmission of the first RS. For example, the information about resources may comprise at least one of the following: an SRS resource ID, a frequency hop ID associated with the SRS resource ID, or a transmission occasion index associated with the SRS resource ID.

In turn, in order for the second device 120-2 to receive and measure the first SRS, the second device 120-1 may transmit 640, to the second device 120-2, the information about resources which was used for the transmission of the first RS.

Upon receiving and measuring the first SRS, the second device 120-1 transmits 645 positioning measurement to the third device.

Similarly, upon receiving and measuring the first SRS, the second device 120-2 transmits 650 positioning measurement to the third device 130.

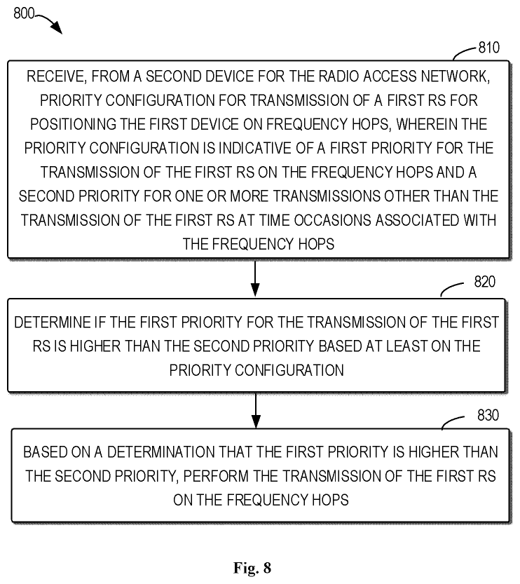

FIG. 8 shows a flowchart of an example method 800 implemented at a first device in accordance with some example embodiments of the present disclosure. For the purpose of discussion, the method 800 will be described from the perspective of the first device 110 with respect to FIG. 1.

At block 810, the first device 110 receives, from a second device for the radio access network, priority configuration for transmission of a first RS for positioning the first device on frequency hops. The priority configuration is indicative of a first priority for the transmission of the first RS on the frequency hops and a second priority for one or more transmissions other than the transmission of the first RS at time occasions associated with the frequency hops.

At block 820, the first device 110 determines if the first priority for the transmission of the first RS is higher than the second priority based at least on the priority configuration.

At block 830, based on a determination that the first priority is higher than the second priority, the first device 110 performs the transmission of the first RS on the frequency hops.

In some embodiments, the one or more transmissions other than the transmission of the first RS comprise transmission of PUSCH.

In some embodiments, the priority configuration comprises at least one of the following: a first number (K) of consecutive frequency hops for the transmission of the first RS, a second number (L) of consecutive frequency hops for the transmission of the first RS, the second number being less than the first number, or a third number (Z) of consecutive frequency hops for reception of a second RS from the second device.

In some embodiments, the first number (K) is associated with first positioning performance for the first device, and the second number (L) is associated with second positioning performance for the first device which is lower than the first positioning performance.

In some embodiments, the method 800 further comprises: receiving, from the second device, a request for retransmission of the first RS using a dedicated frequency hop: and retransmitting the first RS to the second device on the dedicated frequency hop.

In some embodiments, determining if the first priority for the transmission of the first RS is higher than the second priority comprises: determining the first priority for the transmission of the first RS on the first number (K) of consecutive frequency hops to be higher than the second priority.

In some embodiments, determining if the first priority for the transmission of the first RS is higher than the second priority comprises: determining the first priority for the transmission of the first RS on the first number (K) of consecutive frequency hops to be lower than the second priority: and

In some embodiments, in accordance with a determination that the transmission of the first RS is not performed on at least one of the first number (K) of consecutive frequency hops, the first device determines not to perform the transmission of the first RS on remaining consecutive frequency hops among the first number (K) of consecutive frequency hops.

In some embodiments, determining if the first priority for the transmission of the first RS is higher than the second priority comprises: determining the first priority for the transmission of the first RS on the second number (L) of consecutive frequency hops to be lower than the second priority: in accordance with a determination that the transmission of the first RS is successfully performed on the second number (L) of consecutive frequency hops, determining the first priority for the transmission of the first RS on a fourth number consecutive frequency hops to be higher than the second priority.

In some embodiments, determining if the first priority for the transmission of the first RS is higher than the second priority comprises: determining the first priority for the transmission of the first RS on the second number (L) of consecutive frequency hops to be higher than the second priority: and in accordance with a determination that the transmission of the first RS is successfully performed on the second number (L) of consecutive frequency hops, determining the first priority for the transmission of the first RS on a fourth number consecutive frequency hops to be lower than the second priority.

In some embodiments, the priority configuration comprises the first number and the second number, and the fourth number is equal to a difference between the first number (K) and the second number (L).

In some embodiments, the fourth number is equal to a difference between a number of time occasions associated with the transmission of the first RS (M) and the second number (L).

In some embodiments, the method 800 further comprises receiving the second RS from the second device.

In some embodiments, the first device determines if the first priority for the transmission of the first RS is higher than the second priority based on reception and measurement of the second RS.

In some embodiments, determining if the first priority for the transmission of the first RS is higher than the second priority comprises: in accordance with a determination that the second RS is successfully received on a fifth number of consecutive frequency hops and positioning measurement of the second RS is successfully performed on the fifth number of consecutive frequency hops, determining the first priority for the transmission of the first RS to be higher than the second priority.

In some embodiments, the fifth number is received from the second device.

In some embodiments, the fifth number is greater than or equal to the third number (Z).

In some embodiments, the first device determines not to perform the transmission of the first RS on the frequency hops by: determining that the second RS is not successfully received on at least one of the third number (Z) of consecutive frequency hops or positioning measurement of the second RS is not successfully performed on the at least one of the third number (Z) of consecutive frequency hops.

In some embodiments, the method 800 further comprises determining a third priority for measurement of the second RS received from the second device.

In some embodiments, determining the third priority for the measurement of the second RS comprises: in accordance with a determination that the first RS is successfully transmitted on a sixth number of consecutive frequency hops, determining the third priority for the measurement of the second RS to be higher than a fourth priority for receiving or processing at least one channel or at least one signal other than the second RS.

In some embodiments, the sixth number is received from the second device.

In some embodiments, the sixth number is greater than or equal to the first number (K).

In some embodiments, determining the third priority for the measurement of the second RS comprises: in accordance with a determination that the first RS is not successfully transmitted on at least one of a seventh number of consecutive frequency hops, determining the third priority for the measurement of the second RS to be lower than a fourth priority for receiving or processing at least one channel or at least one signal other than the second RS.

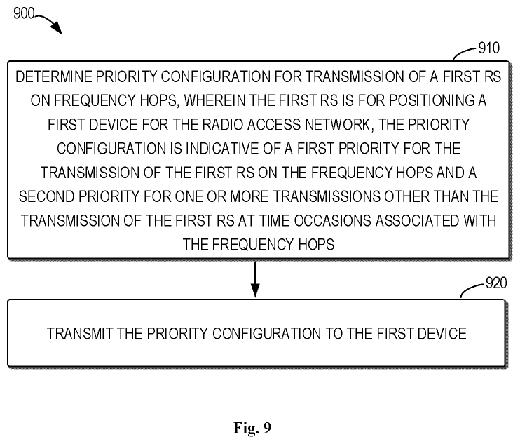

FIG. 9 shows a flowchart of an example method 900 implemented at a second device in accordance with some example embodiments of the present disclosure. For the purpose of discussion, the method 900 will be described from the perspective of the second device 120 with respect to FIG. 1.

At block 910, the second device 120 determines priority configuration for transmission of a first RS on frequency hops, wherein the first RS is for positioning a first device for the radio access network. The priority configuration is indicative of a first priority for the transmission of the first RS on the frequency hops and a second priority for one or more transmissions other than the transmission of the first RS at time occasions associated with the frequency hops.

At block 920, the second device 120 transmits the priority configuration to the first device.

In some embodiments, the one or more transmissions other than the transmission of the first RS comprise transmission of PUSCH.

In some embodiments, the priority configuration comprises at least one of the following: a first number (K) of consecutive frequency hops for the transmission of the first RS, a second number (L) of consecutive frequency hops for the transmission of the first RS, the second number being less than the first number, or a third number (Z) of consecutive frequency hops for reception of a second RS from the second device.

In some embodiments, the first number (K) is associated with first positioning performance for the first device, and the second number (L) is associated with second positioning performance for the first device which is lower than the first positioning performance.

In some embodiments, the method 900 further comprises: transmitting, to the first device, a request for retransmission of the first RS using a dedicated frequency hop: and receiving the first RS from the first device on the dedicated frequency hop.

In some embodiments, determining the priority configuration comprises: causing the first priority for the transmission of the first RS on the first number (K) of consecutive frequency hops to be determined to be higher than the second priority.

In some embodiments, determining the priority configuration comprises: causing the first priority for the transmission of the first RS on the first number (K) of consecutive frequency hops to be determined to be lower than the second priority: and in accordance with a determination that the transmission of the first RS is not performed on at least one of the first number (K) of consecutive frequency hops, causing the transmission of the first RS to be determined not to be performed on remaining consecutive frequency hops among the first number (K) of consecutive frequency hops.

In some embodiments, determining the priority configuration comprises: causing the first priority for the transmission of the first RS on the second number (L) of consecutive frequency hops to be determined to be lower than the second priority: and in accordance with a determination that the transmission of the first RS is successfully performed on the second number (L) of consecutive frequency hops, causing the first priority for the transmission of the first RS on a fourth number consecutive frequency hops to be determined to be higher than the second priority.

In some embodiments, determining the priority configuration comprises: causing the first priority for the transmission of the first RS on the second number (L) of consecutive frequency hops to be determined to be higher than the second priority: and in accordance with a determination that the transmission of the first RS is successfully performed on the second number (L) of consecutive frequency hops, causing the first priority for the transmission of the first RS on a fourth number consecutive frequency hops to be determined to be lower than the second priority.

In some embodiments, the priority configuration comprises the first number and the second number, and the fourth number is equal to a difference between the first number (K) and the second number (L).

In some embodiments, the fourth number is equal to a difference between a number of time occasions associated with the transmission of the first RS (M) and the second number (L).

In some embodiments, the method 900 further comprises transmitting the second RS to the first device.

In some embodiments, determining the priority configuration comprises: causing the first priority for the transmission of the first RS to be determined based on reception and measurement of the second RS.

In some embodiments, determining the priority configuration comprises: in accordance with a determination that the second RS is successfully received on a fifth number of consecutive frequency hops and positioning measurement of the second RS is successfully performed on the fifth number of consecutive frequency hops, causing the first priority for the transmission of the first RS to be determined to be higher than the second priority.

In some embodiments, the method 900 further comprises transmitting the fifth number to the first device.

In some embodiments, the fifth number is greater than or equal to the third number (Z).

In some embodiments, the second RS is not successfully received on at least one of the third number (Z) of consecutive frequency hops or positioning measurement of the second RS is not successfully performed on the at least one of the third number (Z) of consecutive frequency hops. In such embodiments, the transmission of the first RS on the frequency hops is determined not to be performed.

In some embodiments, in accordance with a determination that the first RS is successfully transmitted on a sixth number of consecutive frequency hops, a third priority for measurement of the second RS is determined to be higher than a fourth priority for receiving or processing at least one channel or at least one signal other than the second RS by the first device.

In some embodiments, the sixth number is greater than or equal to the first number (K).

In some embodiments, the method 900 further comprises transmitting the sixth number to the first device.

In some embodiments, in accordance with a determination that the first RS is not successfully transmitted on a seventh number of consecutive frequency hops, a third priority for measurement of the second RS is determined to be lower than a fourth priority for receiving or processing at least one channel or at least one signal other than the second RS by the first device.

In some example embodiments, a first apparatus for a radio access network capable of performing any of the method 800 (for example, the first device 110) may comprise means for performing the respective operations of the method 800. The means may be implemented in any suitable form. For example, the means may be implemented in a circuitry or software module. The first apparatus may be implemented as or included in the first device 110. In some example embodiments, the means may comprise a processor and a memory.

In some example embodiments, the first apparatus comprises: means for receiving, at a first device for a radio access network from a second device for the radio access network, priority configuration for transmission of a first RS for positioning the first device on frequency hops, wherein the priority configuration is indicative of a first priority for the transmission of the first RS on the frequency hops and a second priority for one or more transmissions other than the transmission of the first RS at time occasions associated with the frequency hops: means for determining if the first priority for the transmission of the first RS is higher than the second priority based at least on the priority configuration: and means for performing the transmission of the first RS on the frequency hops based on a determination that the first priority is higher than the second priority.

In some embodiments, the one or more transmissions other than the transmission of the first RS comprise transmission of PUSCH.

In some embodiments, the priority configuration comprises at least one of the following: a first number (K) of consecutive frequency hops for the transmission of the first RS, a second number (L) of consecutive frequency hops for the transmission of the first RS, the second number being less than the first number, or a third number (Z) of consecutive frequency hops for reception of a second RS from the second device.

In some embodiments, the first number (K) is associated with first positioning performance for the first device, and the second number (L) is associated with second positioning performance for the first device which is lower than the first positioning performance.

In some embodiments, the first apparatus further comprises: means for receiving, from the second device, a request for retransmission of the first RS using a dedicated frequency hop: and means for retransmitting the first RS to the second device on the dedicated frequency hop.

In some embodiments, the means for determining if the first priority for the transmission of the first RS is higher than the second priority comprises: means for determining the first priority for the transmission of the first RS on the first number (K) of consecutive frequency hops to be higher than the second priority.

In some embodiments, the means for determining if the first priority for the transmission of the first RS is higher than the second priority comprises: means for determining the first priority for the transmission of the first RS on the first number (K) of consecutive frequency hops to be lower than the second priority: and

In some embodiments, the first apparatus further comprises: in accordance with a determination that the transmission of the first RS is not performed on at least one of the first number (K) of consecutive frequency hops, means for determining not to perform the transmission of the first RS on remaining consecutive frequency hops among the first number (K) of consecutive frequency hops.

In some embodiments, the means for determining if the first priority for the transmission of the first RS is higher than the second priority comprises: means for determining the first priority for the transmission of the first RS on the second number (L) of consecutive frequency hops to be lower than the second priority: in accordance with a determination that the transmission of the first RS is successfully performed on the second number (L) of consecutive frequency hops, means for determining the first priority for the transmission of the first RS on a fourth number consecutive frequency hops to be higher than the second priority.

In some embodiments, the means for determining if the first priority for the transmission of the first RS is higher than the second priority comprises: means for determining the first priority for the transmission of the first RS on the second number (L) of consecutive frequency hops to be higher than the second priority: and in accordance with a determination that the transmission of the first RS is successfully performed on the second number (L) of consecutive frequency hops, means for determining the first priority for the transmission of the first RS on a fourth number consecutive frequency hops to be lower than the second priority.

In some embodiments, the priority configuration comprises the first number and the second number, and the fourth number is equal to a difference between the first number (K) and the second number (L).

In some embodiments, the fourth number is equal to a difference between a number of time occasions associated with the transmission of the first RS (M) and the second number (L).

In some embodiments, the first apparatus further comprises means for receiving the second RS from the second device.

In some embodiments, the means for determining if the first priority for the transmission of the first RS is higher than the second priority comprises: means for determining if the first priority for the transmission of the first RS is higher than the second priority based on reception and measurement of the second RS.

In some embodiments, the means for determining if the first priority for the transmission of the first RS is higher than the second priority comprises: in accordance with a determination that the second RS is successfully received on a fifth number of consecutive frequency hops and positioning measurement of the second RS is successfully performed on the fifth number of consecutive frequency hops, means for determining the first priority for the transmission of the first RS to be higher than the second priority.

In some embodiments, the fifth number is received from the second device.

In some embodiments, the fifth number is greater than or equal to the third number (Z).

In some embodiments, means for determining not to perform the transmission of the first RS on the frequency hops comprises: means for determining that the second RS is not successfully received on at least one of the third number (Z) of consecutive frequency hops or positioning measurement of the second RS is not successfully performed on the at least one of the third number (Z) of consecutive frequency hops.

In some embodiments, the first apparatus further comprises means for determining a third priority for measurement of the second RS received from the second device.

In some embodiments, the means for determining the third priority for the measurement of the second RS comprises: in accordance with a determination that the first RS is successfully transmitted on a sixth number of consecutive frequency hops, means for determining the third priority for the measurement of the second RS to be higher than a fourth priority for receiving or processing at least one channel or at least one signal other than the second RS.

In some embodiments, the sixth number is received from the second device.

In some embodiments, the sixth number is greater than or equal to the first number (K).

In some embodiments, the means for determining the third priority for the measurement of the second RS comprises: in accordance with a determination that the first RS is not successfully transmitted on at least one of a seventh number of consecutive frequency hops, means for determining the third priority for the measurement of the second RS to be lower than a fourth priority for receiving or processing at least one channel or at least one signal other than the second RS.

In some example embodiments, a second apparatus for a radio access network capable of performing any of the method 900 (for example, the second device 120) may comprise means for performing the respective operations of the method 900. The means may be implemented in any suitable form. For example, the means may be implemented in a circuitry or software module. The second apparatus may be implemented as or included in the second device 120. In some example embodiments, the means may comprise a processor and a memory.

In some example embodiments, the second apparatus comprises: means for determining, at a second device for a radio access network, priority configuration for transmission of a first RS on frequency hops, wherein the first RS is for positioning a first device for the radio access network, the priority configuration is indicative of a first priority for the transmission of the first RS on the frequency hops and a second priority for one or more transmissions other than the transmission of the first RS at time occasions associated with the frequency hops; and means for transmitting the priority configuration to the first device.

In some embodiments, the one or more transmissions other than the transmission of the first RS comprise transmission of PUSCH.

In some embodiments, the priority configuration comprises at least one of the following: a first number (K) of consecutive frequency hops for the transmission of the first RS, a second number (L) of consecutive frequency hops for the transmission of the first RS, the second number being less than the first number, or a third number (Z) of consecutive frequency hops for reception of a second RS from the second device.

In some embodiments, the first number (K) is associated with first positioning performance for the first device, and the second number (L) is associated with second positioning performance for the first device which is lower than the first positioning performance.

In some embodiments, the second apparatus further comprises: means for transmitting, to the first device, a request for retransmission of the first RS using a dedicated frequency hop; and means for receiving the first RS from the first device on the dedicated frequency hop.

In some embodiments, the means for determining the priority configuration comprises: means for causing the first priority for the transmission of the first RS on the first number (K) of consecutive frequency hops to be determined to be higher than the second priority.

In some embodiments, the means for determining the priority configuration comprises: means for causing the first priority for the transmission of the first RS on the first number (K) of consecutive frequency hops to be determined to be lower than the second priority: and in accordance with a determination that the transmission of the first RS is not performed on at least one of the first number (K) of consecutive frequency hops, means for causing the transmission of the first RS to be determined not to be performed on remaining consecutive frequency hops among the first number (K) of consecutive frequency hops.

In some embodiments, the means for determining the priority configuration comprises: means for causing the first priority for the transmission of the first RS on the second number (L) of consecutive frequency hops to be determined to be lower than the second priority: and in accordance with a determination that the transmission of the first RS is successfully performed on the second number (L) of consecutive frequency hops, means for causing the first priority for the transmission of the first RS on a fourth number consecutive frequency hops to be determined to be higher than the second priority:

In some embodiments, the means for determining the priority configuration comprises: means for causing the first priority for the transmission of the first RS on the second number (L) of consecutive frequency hops to be determined to be higher than the second priority: and in accordance with a determination that the transmission of the first RS is successfully performed on the second number (L) of consecutive frequency hops, means for causing the first priority for the transmission of the first RS on a fourth number consecutive frequency hops to be determined to be lower than the second priority:

In some embodiments, the priority configuration comprises the first number and the second number, and the fourth number is equal to a difference between the first number (K) and the second number (L).

In some embodiments, the fourth number is equal to a difference between a number of time occasions associated with the transmission of the first RS (M) and the second number (L).

In some embodiments, the second apparatus further comprises means for transmitting the second RS to the first device.

In some embodiments, the means for determining the priority configuration comprises: means for causing the first priority for the transmission of the first RS to be determined based on reception and measurement of the second RS.

In some embodiments, the means for determining the priority configuration comprises: in accordance with a determination that the second RS is successfully received on a fifth number of consecutive frequency hops and positioning measurement of the second RS is successfully performed on the fifth number of consecutive frequency hops, means for causing the first priority for the transmission of the first RS to be determined to be higher than the second priority.

In some embodiments, the second apparatus further comprises means for transmitting the fifth number to the first device.

In some embodiments, the fifth number is greater than or equal to the third number (Z).

In some embodiments, the second RS is not successfully received on at least one of the third number (Z) of consecutive frequency hops or positioning measurement of the second RS is not successfully performed on the at least one of the third number (Z) of consecutive frequency hops. In such embodiments, the transmission of the first RS on the frequency hops is determined not to be performed.

In some embodiments, in accordance with a determination that the first RS is successfully transmitted on a sixth number of consecutive frequency hops, a third priority for measurement of the second RS is determined to be higher than a fourth priority for receiving or processing at least one channel or at least one signal other than the second RS by the first device.

In some embodiments, the sixth number is greater than or equal to the first number (K).

In some embodiments, the second apparatus further comprises means for transmitting the sixth number to the first device.

In some embodiments, in accordance with a determination that the first RS is not successfully transmitted on a seventh number of consecutive frequency hops, a third priority for measurement of the second RS is determined to be lower than a fourth priority for receiving or processing at least one channel or at least one signal other than the second RS by the first device.

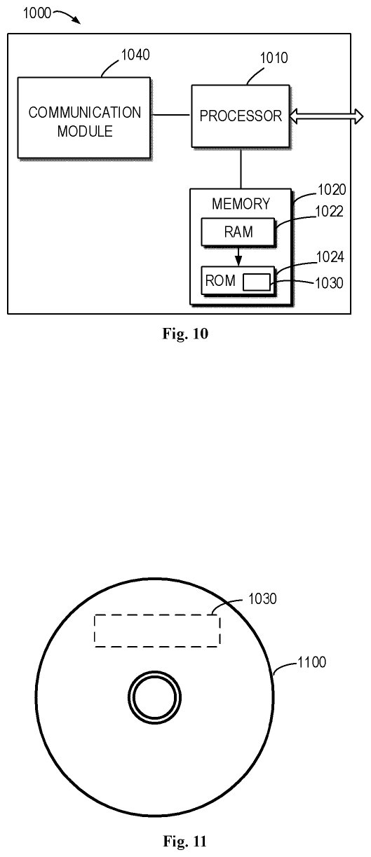

FIG. 10 is a simplified block diagram of a device 1000 that is suitable for implementing example embodiments of the present disclosure. The device 1000 may be provided to implement a communication device, for example, the first device 110, the second device 120, or the third device 130 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that could be executed by the associated processor 1010. The program 1030 may be stored in the memory, e.g., ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIGS. 1 to 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 which may be in form of CD, DVD or other optical storage disk. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be appreciated that though some embodiments may be implemented by/at IAB nodes, solutions including methods and apparatus proposed in this disclosure could also be applied in other communication systems where similar technical problems exist. Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device for a radio access network, comprising:
at least one processor; and
at least one memory storing instructions that, when executed by the at least one processor, cause the first device at least to:
receive, from a second device for the radio access network, priority configuration for transmission of a first reference signal (RS) for positioning the first device on frequency hops, wherein the priority configuration is indicative of a first priority for the transmission of the first RS on the frequency hops and a second priority for one or more transmissions other than the transmission of the first RS at time occasions associated with the frequency hops;
determine if the first priority for the transmission of the first RS is higher than the second priority based at least on the priority configuration; and
based on a determination that the first priority is higher than the second priority, perform the transmission of the first RS on the frequency hops.

2. The first device of claim 1, wherein the one or more transmissions other than the transmission of the first RS comprise transmission of Physical Uplink Shared Channel (PUSCH).

3. The first device of claim 1, wherein the priority configuration comprises at least one of the following:
a first number of consecutive frequency hops for the transmission of the first RS,
a second number of consecutive frequency hops for the transmission of the first RS, the second number being less than the first number, or
a third number of consecutive frequency hops for reception of a second RS from the second device.

4. The first device of claim 3, wherein the first number is associated with first positioning performance for the first device, and the second number is associated with second positioning performance for the first device which is lower than the first positioning performance.

5. The first device of claim 3, wherein the first device is further caused to:
receive, from the second device, a request for retransmission of the first RS using a dedicated frequency hop; and
retransmit the first RS to the second device on the dedicated frequency hop.

6. The first device of claim 3, wherein the first device is caused to determine if the first priority for the transmission of the first RS is higher than the second priority by:
determining the first priority for the transmission of the first RS on the first number of consecutive frequency hops to be higher than the second priority.

7. The first device of claim 3, wherein the first device is caused to determine if the first priority for the transmission of the first RS is higher than the second priority by:
determining the first priority for the transmission of the first RS on the first number of consecutive frequency hops to be lower than the second priority; and
wherein in accordance with a determination that the transmission of the first RS is not performed on at least one of the first number of consecutive frequency hops, the first device is caused to determine not to perform the transmission of the first RS on remaining consecutive frequency hops among the first number of consecutive frequency hops.

8. The first device of claim 3, wherein the first device is caused to determine if the first priority for the transmission of the first RS is higher than the second priority by:
determining the first priority for the transmission of the first RS on the second number of consecutive frequency hops to be lower than the second priority; and
in accordance with a determination that the transmission of the first RS is successfully performed on the second number of consecutive frequency hops, determining the first priority for the transmission of the first RS on a fourth number consecutive frequency hops to be higher than the second priority.

9. The first device of claim 3, wherein the first device is caused to determine if the first priority for the transmission of the first RS is higher than the second priority by:
determining the first priority for the transmission of the first RS on the second number of consecutive frequency hops to be higher than the second priority; and
in accordance with a determination that the transmission of the first RS is successfully performed on the second number of consecutive frequency hops, determining the first priority for the transmission of the first RS on a fourth number consecutive frequency hops to be lower than the second priority.

10. The first device of claim 8, wherein the priority configuration comprises the first number and the second number, and the fourth number is equal to a difference between the first number and the second number.

11. The first device of claim 8, wherein the fourth number is equal to a difference between a number of time occasions associated with the transmission of the first RS and the second number.

12. The first device of claim 3, wherein the first device is further caused to receive the second RS from the second device; and
wherein the first device is caused to determine if the first priority for the transmission of the first RS is higher than the second priority based on reception and measurement of the second RS.

13. The first device of claim 12, wherein the first device is caused to determine if the first priority for the transmission of the first RS is higher than the second priority by:
in accordance with a determination that the second RS is successfully received on a fifth number of consecutive frequency hops and positioning measurement of the second RS is successfully performed on the fifth number of consecutive frequency hops, determining the first priority for the transmission of the first RS to be higher than the second priority.

14. The first device of claim 13, wherein the fifth number is received from the second device.

15. The first device of claim 13, wherein the fifth number is greater than or equal to the third number.

16. The first device of claim 12, wherein the first device is caused to determine not to perform the transmission of the first RS on the frequency hops by:
determining that the second RS is not successfully received on at least one of the third number of consecutive frequency hops or positioning measurement of the second RS is not successfully performed on the at least one of the third number of consecutive frequency hops.

17. The first device of claim 3, wherein the first device is further caused to determine a third priority for measurement of the second RS received from the second device.

18. The first device of claim 17, wherein the first device is caused to determine the third priority for the measurement of the second RS by:
in accordance with a determination that the first RS is successfully transmitted on a sixth number of consecutive frequency hops, determining the third priority for the measurement of the second RS to be higher than a fourth priority for receiving or processing at least one channel or at least one signal other than the second RS.

19. The first device of claim 18, wherein the sixth number is received from the second device.

20-21. (canceled)

22. A second device for a radio access network, comprising:
at least one processor; and
at least one memory storing instructions that, when executed by the at least one processor, cause the second device at least to:
determine priority configuration for transmission of a first reference signal (RS), on frequency hops, wherein the first RS is for positioning a first device for the radio access network, the priority configuration is indicative of a first priority for the transmission of the first RS on the frequency hops and a second priority for one or more transmissions other than the transmission of the first RS at time occasions associated with the frequency hops; and
transmit the priority configuration to the first device.

23-46. (canceled)
